(19) United States
(12) Patent Application Publication
(10) Pub. No.: US 2008/0294824 A1
(43) Pub. Date: Nov. 27, 2008

(54) DEVICE INFORMATION MANAGEMENT SYSTEMS AND METHODS

(75) Inventor: Hsiao-Fung Chou, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/935,426

(22) Filed: Nov. 6, 2007

(30) Foreign Application Priority Data
May 21, 2007 (TW) 96118034

(51) Int. Cl. G06F 13/364

(52) U.S. Cl. 710/113

(57) ABSTRACT

Device information management systems and methods for use in a computer system are provided. The system comprises an application device, a south bridge chip, a memory and an arbitrator. The application device and the south bridge chip couple to the arbitrator, and couple to the memory via the arbitrator. The arbitrator receives an access request from a specific device among the application devices and the south bridge chip. When data transmission between the arbitrator and the memory is idle, the arbitrator transmits a grant signal to the specific device. After receiving the grant signal, the specific device begins access from the memory.

### BACKGROUND OF THE INVENTION

1. Field of the Invention

The disclosure relates generally to device information management systems and methods, and, more particularly to systems and method that store and manage related information for application devices and a south bridge chip in a shared memory.

2. Description of the Related Art

ROM, such as EEPROM (Electrically Erasable Programmable Read-Only Memory) is a type of non-volatile memory device commonly applied in motherboard and component designs of a computer system. Data stored in EEPROM is secure until a software program or hardware device issues an erase command.

Important units and related application devices of a computer system will store important data in EEPROM, such that software programs or hardware devices can use the data in EEPROM, and the data stored in EEPROM will not be lost if the computer system shuts down. For example, a LAN (Local Area Network) chip stores device information comprising PHY (Physical) ID (identification), MAC (Media Access Control) address and Vendor/System ID in EEPROM. When an application device such as a network chip or a LAN MAC of a network adapter needs related data, the data can be read from the EEPROM.

FIG. 1 is a schematic diagram illustrating a conventional computer system. In FIG. 1, the computer system 100 comprises at least one application device 110 and a south bridge chip 120. The south bridge chip 120 is used to couple with peripheral devices of the computer system 100. The computer system 100 has a first memory 111 and a second memory 121, for storing data, coupled to the application device 110 and the south bridge chip 120, respectively. Specifically, when the application device 110 and the south bridge chip 120 need related data, they can access the data from the first memory 111 and the second memory 121, respectively.

When several application devices on a motherboard respectively need EEPROM for storage, several EEPROMs must be provided for the respective devices. Since EEPROM is expensive, additional costs are required for setting up the EEPROMs. However, in general, the respective EEPROMs are often not fully occupied with lots of available space. Therefore, the invention stores and manages related information for application devices and a south bridge chip via a shared memory.

### BRIEF SUMMARY OF THE INVENTION

Device information management systems and methods are provided.

An embodiment of a device information management system comprises an application device, a south bridge chip, a memory and an arbitrator. The application device and the south bridge chip couple to the arbitrator, and couple to the memory via the arbitrator. The arbitrator receives an access request from a specific device among the application device and the south bridge chip. When data transmission between the arbitrator and the memory is idle, the arbitrator transmits a grant signal to the specific device. After receiving the grant signal, the specific device begins access from the memory.

In an embodiment of a device information management method, an application device, a south bridge chip, a memory and an arbitrator are provided in a computer system, wherein the application device and the south bridge chip couple to the arbitrator, and couple to the memory via the arbitrator. The arbitrator receives an access request from a specific device among the application device and the south bridge chip. When data transmission between the arbitrator and the memory is idle, the arbitrator transmits a grant signal to the specific device. After receiving the grant signal, the specific device begins access from the memory.

An embodiment of a device information management system comprises an application device, a south bridge chip, a memory and an arbitrator. The arbitrator couples to the application device and the south bridge chip, and couples to the memory via a bus. The arbitrator receives an access request from a specific device among the application device and the south bridge chip. When the bus is idle, the arbitrator transmits a grant signal to the specific device. After receiving the grant signal, the specific device begins access from the memory.

In an embodiment of a device information management method, an application device, a south bridge chip, a memory and an arbitrator are provided in a computer system, wherein the arbitrator couples to the application device and the south bridge chip, and couples to the memory via a bus. The arbitrator receives an access request from a specific device among the application devices and the south bridge chip. When the bus is idle, the arbitrator transmits a grant signal to the specific device. After receiving the grant signal, the specific device begins access from the memory.

Device information management systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a conventional computer system;

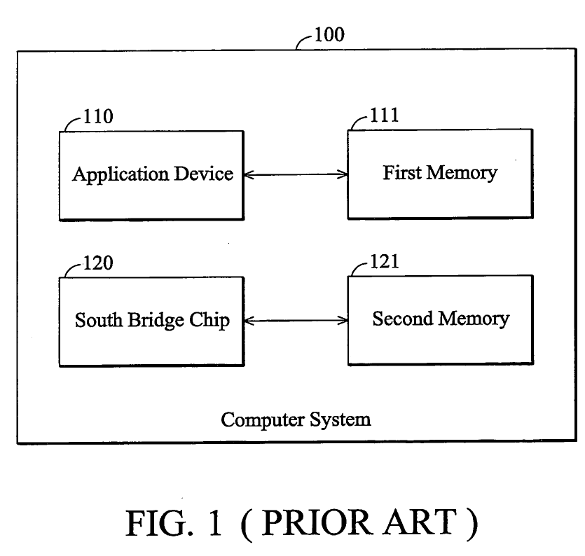

FIG. 2 is a schematic diagram illustrating an embodiment of a device information management system according to the invention; and

FIG. 3 is a flowchart of an embodiment of a device information management method according to the invention.

### DETAILED DESCRIPTION OF THE INVENTION

Device information management systems and methods are provided.

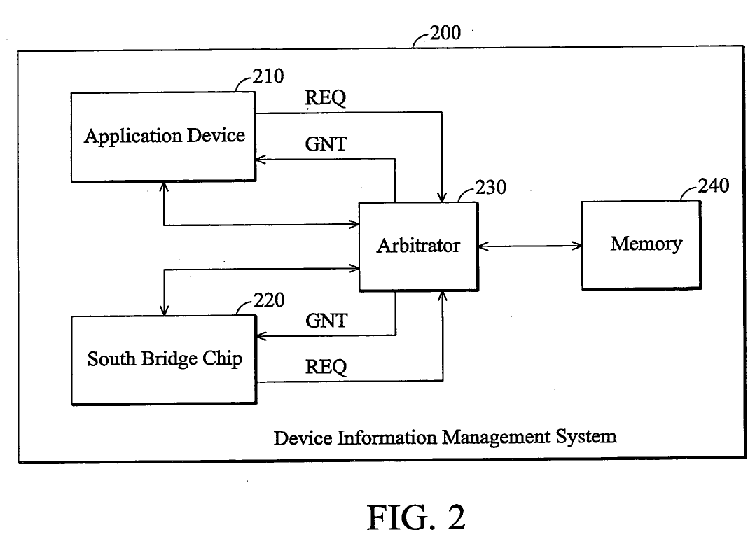

FIG. 2 is a schematic diagram illustrating an embodiment of a device information management system according to the invention.

The device information management system 200 is suitable for use in a computer system. The device information management system 200 comprises an application device 210, a south bridge chip 220, an arbitrator 230, and a memory 240. The application device 210 may be a LAN, VGA, or RAID (Redundant Array of Inexpensive Disks) controllers. The south bridge chip 220 is used to couple with peripheral devices of the computer system. The memory 240 may be a SPI (Serial Peripheral Interface) Flash ROM. The application device 210 and the south bridge chip 220 can store respective device information required for operating in the memory 240. The device information for the LAN controller may comprise a PHY ID or a MAC address.

The arbitrator 230 couples to the memory 240 via a bus. The arbitrator 230 determines the access right of the bus according to the condition of data transmission between the arbitrator 230 and the memory 240, and/or according to the condition of the bus. For example, when the application device 210 or the south bridge chip 220 wants to access the memory 240, an access request (REQ) is transmitted to the arbitrator 230. When the data transmission between the arbitrator 230 and the memory 240 is idle or the bus is idle, the arbitrator 230 transmits a grant signal (GNT) to the application device 210 or the south bridge chip 220 transmitting the access request. When the grant signal is received, the application device 210 or the south bridge chip 220 obtains the access right to access the memory 240. It is understood that, in some embodiments, if the application device 210 and the south bridge chip 220 both want to access the memory 240, and respectively transmit an access request (REQ) to the arbitrator 230, the arbitrator 230 can provide the access right of the bus to the application device 210 and the south bridge chip 220 according to the received order of the corresponding access requests. That is, the data transmission corresponding to the latter access request is performed after the data transmission corresponding to the former access request is finished.

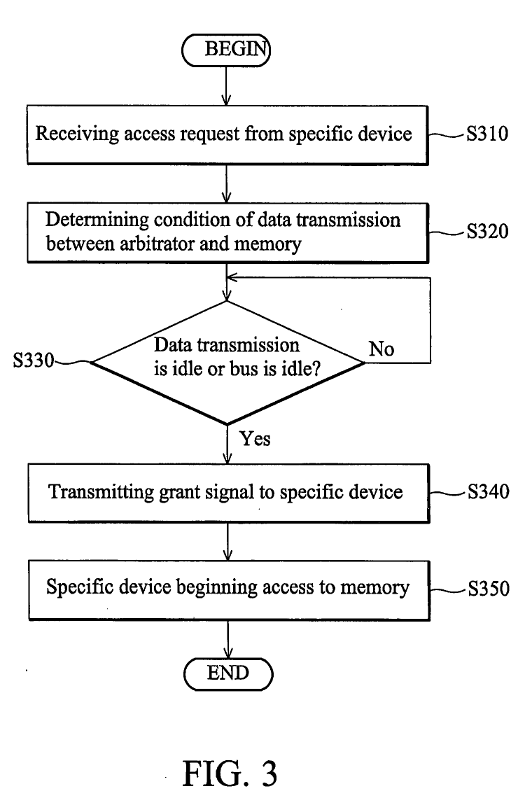

FIG. 3 is a flowchart of an embodiment of a device information management method according to the invention.

In step S310, the arbitrator receives an access request from a specific device among the application devices, such as LAN, VGA, and RAID controllers, and the south bridge chip. When the access request is received from the specific device, the arbitrator stores the access request in FIFO (first-in, first-out) queue (not shown). In step S320, the condition of data transmission between the arbitrator and the memory is determined. That is, it is determined whether any data is currently being transmitted between the arbitrator and the memory in step S320. It is understood that the data transmission may correspond to the access requests of the application device, the south bridge chip, or other devices. If data transmission is currently being performed between the arbitrator and the memory (No in step S330), the procedure returns to step S320 to determine the condition of data transmission between the arbitrator and the memory. If the data transmission between the arbitrator and the memory is idle or the bus between the arbitrator and the memory is idle (Yes in step S330), in step S340, the arbitrator transmits a grant signal to the specific device transmitting the access request. After receiving the grant signal, in step S350, the specific device obtains the access right of the bus, and begins access from the memory. It is noted that, as described, the arbitrator can provide the access right of the bus to the application device and the south bridge chip according to the received order of the corresponding access requests.

In the invention, related information for the application devices and the south bridge chip can be stored and managed in a shared memory using an arbitrator.

Device information management systems and methods, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A device information management system for use in a computer system, comprising:
an application device;
a south bridge chip;
a memory; and
an arbitrator coupled to the application device and the south bridge chip, wherein the application device and the south bridge chip couple to the memory via the arbitrator, the arbitrator receiving an access request from a specific device among the application device and the south bridge chip, and transmitting a grant signal to the specific device when data transmission between the arbitrator and the memory is idle, and the specific device beginning access from the memory after receiving the grant signal.

2. The system of claim 1 wherein the specific device accesses device information required by the specific device for operating from the memory.

3. The system of claim 2 wherein the device information comprises a PHY ID (Physical Identification) or MAC (Media Access Control) address if the application device comprises a LAN controller.

4. The system of claim 1 wherein the application device comprises a LAN, VGA or RAID controller.

5. The system of claim 1 wherein the memory comprises a SPI Flash ROM.

6. A device information management method, comprising:
providing an application device, a south bridge chip, a memory and an arbitrator in a computer system, wherein the application device and the south bridge chip couple to the arbitrator, and couple to the memory via the arbitrator;
receiving an access request from a specific device among the application device and the south bridge chip by the arbitrator;
transmitting a grant signal to the specific device by the arbitrator when data transmission between the arbitrator and the memory is idle; and
beginning access from the memory by the specific device after receiving the grant signal.

7. The method of claim 6 further comprising accessing device information required by the specific device for operating from the memory by the specific device.

8. The method of claim 7 wherein the device information comprises a PHY ID (Physical Identification) or MAC (Media Access Control) address if the application device comprises a LAN controller.

9. The method of claim 6 further comprising storing the access request in a FIFO (first-in, first-out) queue after receiving the access request from the specific device among the application device and the south bridge chip by the arbitrator.

10. The method of claim 6 wherein the application device comprises a LAN, VGA or RAID controller.

11. The system of claim 6 wherein the memory comprises a SPI Flash ROM.

12. A device information management system for use in a computer system, comprising:
an application device;
a south bridge chip;
a memory; and
an arbitrator coupled to the application device and the south bridge chip, and coupled to the memory via a bus, the arbitrator receiving an access request from a specific device among the application device and the south bridge chip, and transmitting a grant signal to the specific device when the bus is idle, and the specific device obtaining an access right to the memory and beginning access from the memory after receiving the grant signal.

13. The system of claim 12 wherein the application device comprises a LAN, VGA or RAID controller.

14. The system of claim 12 wherein the arbitrator provides the access right of the bus to the application device and the south bridge chip according to the received order of the corresponding access requests.

15. A device information management method, comprising:
providing an application device, a south bridge chip, a memory and an arbitrator in a computer system, wherein the application device and the south bridge chip couple to the arbitrator, and the arbitrator couples to the memory via a bus;
receiving an access request from a specific device among the application device and the south bridge chip by the arbitrator;
transmitting a grant signal to the specific device by the arbitrator when the bus is idle; and
obtaining an access right to the memory, and beginning access from the memory by the specific device after receiving the grant signal.

16. The method of claim 15 further comprising storing the access request in a FIFO (first-in, first-out) queue after receiving the access request from the specific device among the application device and the south bridge chip by the arbitrator.

17. The method of claim 15 wherein the application device comprises a LAN, VGA or RAID card controller.
